(19) United States
(12) Patent Application Publication
(10) Pub. No.: US 2012/0292142 A1
(43) Pub. Date: Nov. 22, 2012

(54) Cable-Operated Device

(75) Inventors: Yuichi Hasegawa, Nagoya (JP); Yoshikatsu Tsuge, Nagoya (JP)

(73) Assignee: CHUO HATSUJO KABUSHIKI KAISHA, Nagoya-shi, Aichi (JP)

(21) Appl. No.: 13/575,010

(22) PCT Filed: Feb. 7, 2011
(86) PCT No.: PCT/JP2011/052520

§ 371 Date: Jul. 24, 2012

(30) Foreign Application Priority Data
Feb. 24, 2010 (JP) 2010-038123

(51) Int. Cl. B60T 11/04

(52) U.S. Cl. 188/2 D

(57) ABSTRACT

In a cable-operated device, one end of a coil spring 56 is fixed to a brake lever and another end of the coil spring 56 is fixed to a supporting member. At least one of the brake lever and the supporting member has a guide surface 58b making contact with the coil spring 56 from a lateral direction with respect to the coil spring 56. One end portion of the coil spring 56 has a first pitch portion 56b wound with a first pitch, a second pitch portion 56a wound with a second pitch which is smaller than the first pitch, and a third pitch portion 56c wound with a third pitch which is larger than the second pitch. When a primary load is applied to the coil spring 56, a length of the coil spring 56 is 80 to 120 mm, adjacent windings of the first pitch portion are separated from each other, adjacent windings of the second pitch portion are in contact with each other, and the second pitch portion makes contact with a tip end of the guide surface 58b.

### TECHNICAL FIELD

The present application relates to a cable-operated device for a parking brake device of an automobile.

### BACKGROUND ART

This type of cable-operated device comprises a brake lever, a cable having one end connected to the brake lever, and a coil spring that guides the cable. When a driver operates a parking brake lever, an operational force thereof is transferred to the brake lever via the cable. Consequently, the brake lever moves from a set position to a braking position and a braking force is applied to a tire of the automobile. In a state where the brake lever is moved to the braking position, the coil spring is compressed and biases the brake lever toward the set position. As the driver operates the parking brake lever and releases the braking force, due to a biasing force of the coil spring, the brake lever returns from the braking position to the set position. Japanese Patent Application Publication No. 2009-150468 discloses a prior art of cable-operated devices.

### SUMMARY OF INVENTION

### Technical Problem

A cable-operated device of this type normally comprises a supporting member that supports one end of the coil spring. A guide surface that guides the coil spring is formed on the supporting member. The guide surface makes contact with a lateral surface of the coil spring and guides the coil spring. When the coil spring is stretched or compressed, the coil spring slides against the guide surface. Therefore, the coil spring is subject to wear by the guide surface and endurance of the coil spring decreases. Thus, it is desirable to realize a technique for suppressing a decrease in the endurance of the coil spring.

In addition, downsizing of parking brake devices has recently been studied in order to achieve automotive lightening. Downsizing of the parking brake device requires downsizing of the cable-operated device used in the parking brake device. In order to achieve downsizing of the cable-operated device, it is required that a set length of the coil spring (i.e., a length of the coil spring when a primary load is applied thereto) be reduced. However, even when the set length of the coil spring is reduced, the lever operation by the driver must be reliably transferred to the brake lever. To this end, an operation amount of the parking brake lever (i.e., a range of movement of the brake lever) desirably remains unchanged. Therefore, simply reducing the length of the coil spring results in increased stress generated on the coil spring when the coil spring is compressed. When the stress generated on the coil spring increases, a material strength or an outside diameter of the coil spring must be increased accordingly. Increasing the material strength of the coil spring is difficult in terms of cost, while increasing the outside diameter of the coil spring runs counter to the demands for downsizing of the cable-operated devices. For this reason, at the current moment, a workable downsized cable-operated device has not yet been realized.

It is an object of the present application to realize a downsized cable-operated device by increasing endurance of a coil spring and, at the same time, suppressing stress generated on the coil spring.

### Solution to Technical Problem

As a result of an endurance test performed by the present inventors, it has been revealed that breakage of a coil spring due to the coil spring sliding against a guide surface occurs at a portion that slides against a tip end of the guide surface. In other words, it has been revealed that, while the coil spring slides against the entire guide surface, breakage of the coil spring occurs in a vicinity of a position that slides against the tip end of the guide surface. Therefore, it has been found that, in order to improve endurance of the coil spring, it is important to improve endurance of the portion that slides against the tip end of the guide surface. The cable-operated device disclosed in the present specification has been devised based on the above findings.

The cable-operated device disclosed in the present specification comprises a brake lever, a cable having one end connected to the brake lever, a supporting member that supports the cable along a pathway on which the cable is arranged, and a coil spring having one end fixed to the brake lever and another end fixed to the supporting member. The cable may be inserted in a hole within the coil spring. At least one of the brake lever and the supporting member may comprise a guide surface making contact with the coil spring from a lateral direction with respect to the coil spring. One end portion of the coil spring may comprise a first pitch portion wound with a first pitch, a second pitch portion wound with a second pitch which is smaller than the first pitch, and a third pitch portion wound with a third pitch which is larger than the second pitch. The first pitch portion, the second pitch portion, and the third pitch portion may be arranged in order from a tip of the one end portion. When a primary load is applied to the coil spring, a length of the coil spring is 80 to 120 mm, adjacent windings of the first pitch portion are separated from each other, adjacent windings of the second pitch portion are in contact with each other, and the second pitch portion makes contact with a tip end of the guide surface.

In this cable-operated device, the first to third pitch portions are provided on the one end portion of the coil spring, and the coil pitch of the second pitch portion is set smaller than the coil pitches of the first and third pitch portions. In addition, when the coil spring enters a set state, adjacent windings of the second pitch portion come into contact with each other, and a contact portion of the second pitch portion abuts the tip end of the guide surface. Since the adjacent windings are in contact with each other at the portion abutting the tip end of the guide surface, contact pressure applied to each adjacent winding of the coil spring can be suppressed and endurance of the coil spring can be improved. Furthermore, since the coil pitch of the first pitch portion that abuts the guide surface is set larger than the coil pitch of the second pitch portion, the first pitch portion functions as a spring. Therefore, stress applied to the coil spring can be suppressed. As a result, a small-size cable-operated device with the coil spring length of 80 to 120 mm in the set state can be realized without having to increase material strength of the coil spring or increase an outside diameter of the coil spring.

In this case, a set state refers to a state in which the brake lever is at a set position, the coil spring is fixed to the supporting member and the brake lever, and a load applied to the coil spring is arranged. When the coil spring enters the set state, a primary load is applied to the coil spring.

In the above cable-operated device, it is preferable that when the primary load is applied to the coil spring, a first distance from one end of the second pitch portion to the tip end of the guide surface is 3 to 5 mm, and a second distance from another end of the second pitch portion to the tip end of the guide surface is 3 to 5 mm. According to a test performed by the present inventors, the endurance of the coil spring can be improved dramatically by setting the distances to 3 mm or more. The stress applied to the coil spring can be suppressed preferably by setting the distances to 5 mm or less.

In the above cable-operated device, it is preferable that when no load is applied to the coil spring, the adjacent windings of the second pitch portion are separated from each other. According to this configuration, surface treatment (e.g., plate processing, etc) can be applied to the second pitch portion wound with the smaller pitch.

Further, in the above cable-operated device, it is preferable that another end portion of the coil spring comprises a first pitch portion wound with the first pitch, a second pitch portion wound with the second pitch, and a third pitch portion wound with the third pitch, and the first pitch portion, the second pitch portion, and the third pitch portion are arranged in order from a tip of the another end portion. According to this configuration, the coil spring can be arranged without having to check an orientation of the coil spring, thereby enabling mountability of the coil spring to be improved.

### BRIEF DESCRIPTION OF DRAWINGS

FIG. 1 is a plan view of a parking brake device according to an embodiment.

FIG. 2 is a cross-sectional view taken along II-II in FIG. 1.

FIG. 3 is a side view of a coil spring.

FIG. 4 is a cross-sectional view illustrating a vicinity of a supporting member in a state where a lower end of a brake lever and the supporting member are closest to each other.

FIG. 5 is a graph illustrating results of a verification experiment of endurance of the coil spring in which a distance from an and of a second pitch portion to a tip end of a guide surface in a set state is used as a parameter.

### DETAILED DESCRIPTION OF INVENTION

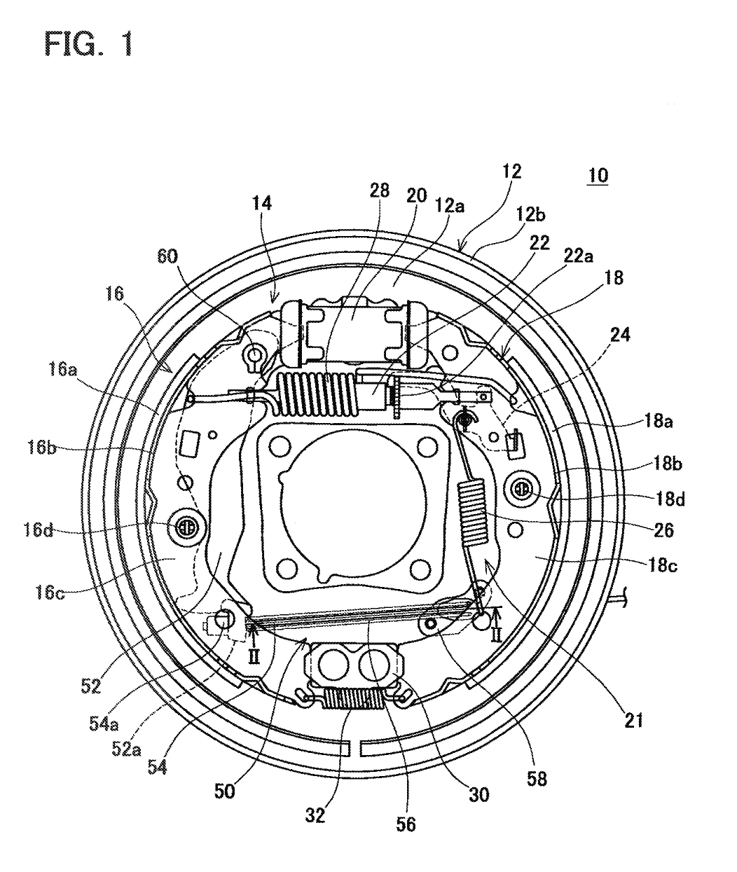

FIG. 1 is a partially extracted view of a drum parking brake device 10 arranged on a rear wheel of an automobile. The parking brake device 10 comprises a back plate 12, a brake shoe assembly 14, and a cable-operated device 50.

The back plate 12 comprises a disk-shaped base 12a and a cylindrical outer periphery 12b along an outer peripheral edge of the base 12a. A brake drum (not shown) is arranged along the outer periphery 12b.

The brake shoe assembly 14 comprises brake shoes 16 and 18, a cylinder 20, a separation adjusting device 21, coil springs 28 and 32, and an anchor member 30. The brake shoes 16 and 18 are respectively supported by the base 12a of the back plate 12. The brake shoes 16 and 18 are arranged so as to be left-right symmetrical. The brake shoe 16 comprises a lining 16a, a rib 16b, and a web 16c. The web 16c has a flat plate shape. The web 16c is arranged approximately parallel to the back plate 12. The web 16c is elastically supported on the base 12a by a shoe supporting member 16d. An outside edge (a left-side edge in FIG. 1) of the web 16c is formed in an arc shape. The rib 16b is fixed approximately vertical to the outside edge of the web 16c. The lining 16a is pasted to an outside surface of the rib 16b.

In the same manner as the brake shoe 16, the brake shoe 18 comprises a lining 18a, a rib 18b, and a web 18c. The web 18c is elastically supported on the base 12a by a shoe supporting member 18d. Since the brake shoe 18 is configured approximately the same as the brake shoe 16, descriptions of portions overlapping the description of the brake shoe 16 will be omitted. The brake shoe 18 is arranged so as to be left-right symmetrical with respect to the brake shoe 16.

Upper ends of the webs 16c and 18c respectively engage a piston (not shown) inside the cylinder 20. The cylinder 20 is fixed to the base 12a. The coil spring 28 is arranged below the cylinder 20. A left end of the coil spring 28 engages the web 16c and a right end of the coil spring 28 engages the web 18c. The coil spring 28 biases the brake shoes 16 and 18 in a direction in which separation between the brake shoes 16 and 18 is reduced. In addition, the coil spring 32 is arranged on the side of lower ends of the webs 16c and 18c. A left end of the coil spring 32 engages the lower end of the web 16c and a right end of the coil spring 32 engages the lower end of the web 18c. The coil spring 32 biases the brake shoes 16 and 18 in a direction in which separation between the brake shoes 16 and 18 is reduced. The anchor member 30 is arranged above the coil spring 32. The anchor member 30 respectively supports the lower ends of the webs 16c and 18c.

The separation adjusting device 21 comprises a strut 22, a lever 24, and a coil spring 26. The strut 22 is inserted through an inner hole of the coil spring 28. A right end of the strut 22 engages the web 18c. A left end of the strut 22 engages a brake lever 52, to be described later. The strut 22 comprises a dial 22a that adjusts a longitudinal (left-right direction in FIG. 1) length of the strut 22. The dial 22a is arranged so as to be able to abut one end of the lever 24. The lever 24 is pivotably supported at the right end of the strut 22. The lever 24 is biased counter-clockwise by the coil spring 26. One end of the coil spring 26 engages the web 18c. As required, the separation adjusting device 21 rotationally moves the dial 22a to adjust a length of the strut 22. Accordingly, the separation between the brake shoes 16 and 18 is adjusted and a length and a set load of the coil spring 56, to be described later, are also adjusted.

The cable-operated device 50 comprises a cable 54, a brake lever 52, a coil spring 56, and a supporting member 58. The brake lever 52 is arranged between the web 16c and the base 12a. The brake lever 52 has a flat plate shape that extends in an up-down direction of the braking device 10. An upper end of the brake lever 52 is pivotably supported by a fixed pin 60 that penetrates an upper portion of the web 16c. The left end of the strut 22 engages the brake lever 52 below the pin 60. A cable supporting portion 52a is formed at a lower end of the brake lever 52. The cable supporting portion 52a has a cross section that is shaped like a U-groove. The cable supporting portion 52a supports one end of the cable 54. The surface of the cable 54 over the entire length thereof is coated with resin. The cable 54 is inserted through an inner hole of the coil spring 56. A pillar-shaped cable end 54a whose diameter is greater than a coil diameter of ends of the coil spring 56 is fixed to one end of the cable 54. The cross section of the cable end 54a may have a polygonal shape such as a quadrangular prism shape or a hexagonal column shape. The cable end 54a abuts a left end of the cable supporting portion 52a. Accordingly, the cable 54 is fixed to the brake lever 52. A parking brake lever (not shown) is connected to another end of the cable 54.

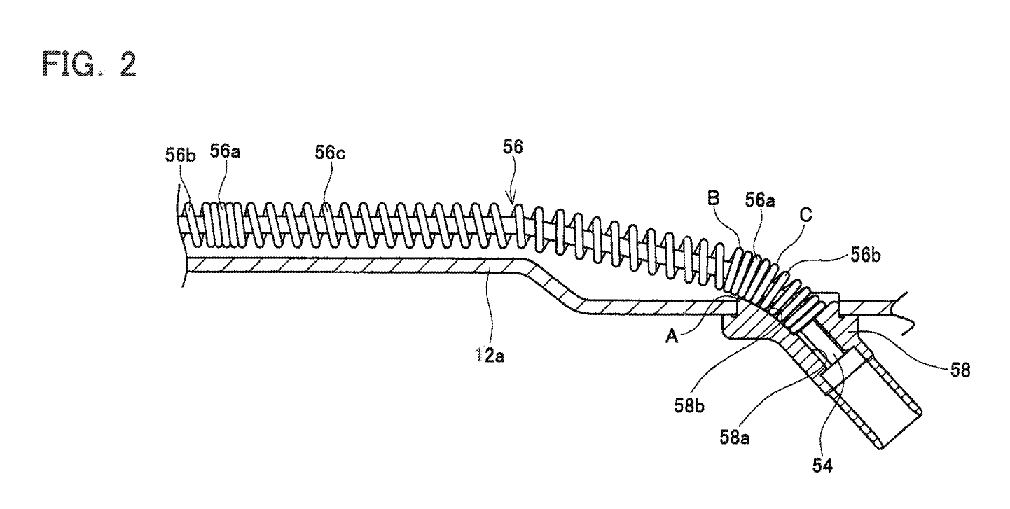

A right end of the coil spring 56 is supported by the supporting member 58. The cable 54 is routed through a through-hole 58a of the supporting member 58 and is supported by the supporting member 58. FIG. 2 illustrates a cross-section II-II of FIG. 1. FIG. 2 illustrates a state (set state) where the parking brake has been released and where the lower end of the brake lever 52 and the supporting member 58 are at positions most separated from each other. In other words, a state is illustrated where the coil spring 56 is mounted to the cable-operated device 50 and where the length of the strut 22 is adjusted by the separation adjusting device 21. As illustrated in FIG. 2, the cable 54 is passed through the through-hole 58a of the supporting member 58. A guide surface 58b is formed on the supporting member 58.

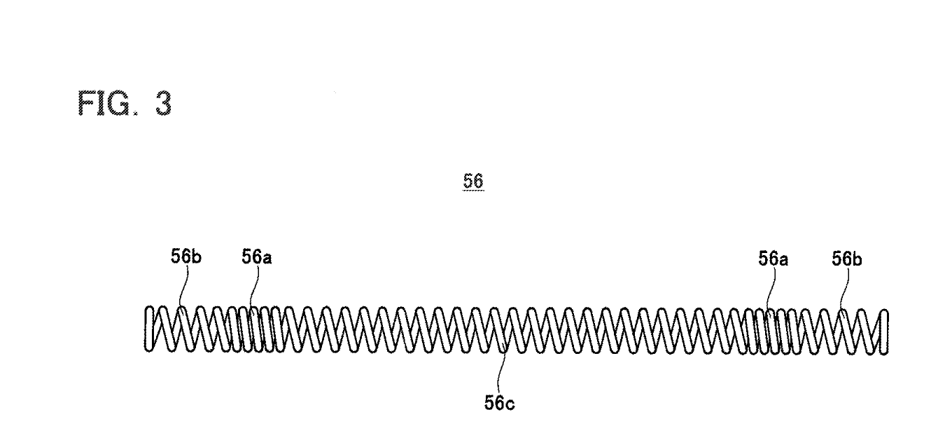

FIG. 3 is a side view of the coil spring 56 when the coil spring 56 is in a natural state. In this case, a natural state refers to a state where no external forces are applied to the coil spring 56. The coil spring 56 is fabricated by a steal wire having a constant wire diameter. The wire diameter of the coil spring 56 may be set to, for example, 0.8 to 1.4 mm. In addition, an inner diameter of the coil spring 56 is constant and may be set to, for example, 4.5 to 6.0 mm. By setting the inner diameter of the coil spring 56 to 4.5 mm or more, a space through which the cable 54 passes may be suitably secured inside the coil spring 56. In addition, an outer diameter of the coil spring may be set to, for example, 6.1 to 8.0 mm. By setting the outer diameter of the coil spring 56 to 8.0 mm or less, space can be conserved and interference with other members can be suitably prevented.

The coil spring 56 comprises a first pitch portion 56b, a second pitch portion 56a, and a third pitch portion 56c. The first pitch portion 56b is formed at each end of the coil spring 56. The first pitch portions 56b formed at the respective ends have equal lengths. The second pitch portion 56a is also formed at each end of the coil spring 56 in continuation toward a center side from the corresponding first pitch portion 56b. A coil pitch of the second pitch portions 56a is smaller than a coil pitch of the first pitch portions 56b. The second pitch portions 56a formed at the respective ends also have equal lengths. The third pitch portion 56c is formed between the second pitch portions 56a. A coil pitch of the third pitch portion 56c is larger than the coil pitch of the second pitch portions 56a and is the same as the coil pitch of the first pitch portions 56b. Since the first pitch portions 56b and the second pitch portions 56a are formed at the respective ends of the coil spring 56, the coil spring 56 can be arranged between the webs 16c and 18c without having to check an orientation of the coil spring 56, thereby enabling mountability of the coil spring to be improved.

As is apparent from FIG. 3, when the coil spring 56 is in a natural state, a gap is also formed between adjacent windings of each second pitch portion 56a. Favorably, a separation between the adjacent windings of the second pitch portion 56a is, for example, 0.1 mm or greater in a natural state. By forming the gap between the adjacent windings of the second pitch portion 56a, surface treatment can also be suitably applied to the adjacent windings of the second pitch portion 56a. In other words, a surface of the coil spring 56 may be subjected to surface treatment (e.g., plate processing) in order to improve corrosion resistance or the like. By forming the gap of 0.1 mm or greater between the adjacent windings of the second pitch portion 56a, surface treatment can be suitably applied to the surface of the second pitch portion 56a. Moreover, separations between adjacent windings of the first pitch portion 56b and the third pitch portion 56c can be set to, for example, 0.6 to 1.4 mm.

As illustrated in FIG. 2, in a state where the coil spring 56 is set to the parking brake device 10, the coil spring 56 is in contact with the guide surface 58b of the supporting member 58 and is bent. Specifically, one first pitch portion 56b and one second pitch portion 56a of the coil spring 56 are in contact with the guide surface 58b. In this state, gaps are formed between the adjacent windings of this first pitch portion 56b and the third pitch portion 56c, respectively, but no gaps are formed between the adjacent windings of this second pitch portion 56a. In other words, in the second pitch portion 56a, the adjacent windings are in contact with each other. A contact portion (point B to point C) where the adjacent windings of the second pitch portion 56a are in contact with each other abuts a tip end (point A) of the guide surface 58b. In the present embodiment, specifications of the coil spring 56 are set such that a distance between one end (point B) of the contact portion to the tip end (point A) of the guide surface 58b is 3.0 to 5.0 mm and that a distance between another end (point C) of the contact portion to the tip end (point A) of the guide surface 58b is 3.0 to 5.0 mm.

In addition, in the present embodiment, a length of the coil spring 56 is set to 80 to 120 mm in a state where the coil spring 56 is set to the parking brake device 10. By keeping the length of the coil spring 56 in the set state to or below 120 mm, a compact parking brake device 10 is achieved. Furthermore, by providing the coil spring 56 with the length in the set state equal to or greater than 80 mm, an outer diameter of the parking brake device 10 can be secured to a certain degree and sufficient braking force can be obtained.

Moreover, a natural length of the coil spring 56 may be set so as to be greater than the length of the coil spring 56 in the set state by at least 5 mm or more. Accordingly, floppiness of the coil spring 56 in the set state is prevented. In addition, specifications of the coil spring 56 may be set such that a spring load of the coil spring 56 in the set state is 20 to 30 N and the coil spring has a spring constant of 2 N/mm or smaller. Such load characteristics of the coil spring 56 enables a sufficient restoring force to be applied to the cable 54 and, at the same time, a spring force of the coil spring 56 can be prevented from affecting the braking force of the parking brake device 10.

Next, operations of the parking brake device 10 will be described. When a driver of the automobile operates the parking brake lever and the cable 54 is pulled toward the right-hand side of FIG. 1, the brake lever 52 rotationally moves counter-clockwise around the pin 60. Accordingly, the brake shoe 18 is moved via the strut 22 with the anchor member 30 as a supporting point in a separating direction from the brake shoe 16. In association thereto, the brake shoe 1 is also moved with the anchor member 30 as a supporting point in a separating direction from the brake shoe 18. As a result, the brake shoes 16 and 18 come into contact with an inner peripheral surface of a drum. Consequently, the parking brake is enabled. In this state, a force in a compressing direction is applied to the coil spring 56 by the brake lever 52 and the supporting member 58. When the driver of the automobile operates the parking brake lever and a tensile force of the cable 54 is relaxed, due to a biasing force of the coil spring 56, the brake lever 52 rotationally moves clockwise around the pin 60. Accordingly, the brake shoes 16 and 18 are moved in directions approaching each other and the parking brake is released.

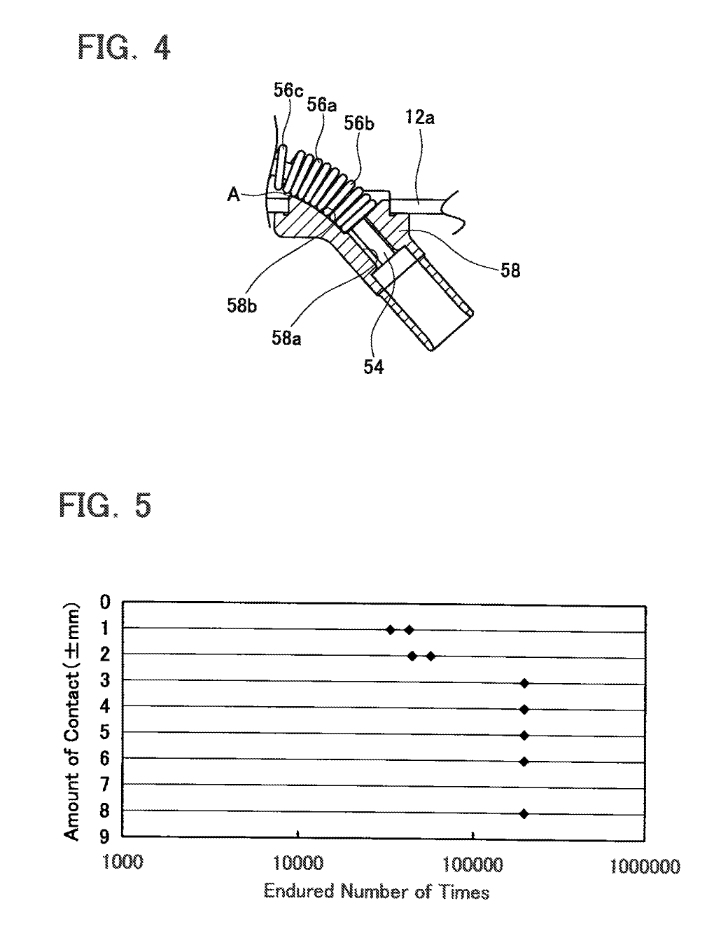

When the cable 54 is pulled toward the right-hand side of FIG. 1, the separation between the lower end of the brake lever 52 and the supporting member 58 is reduced and the coil spring 56 is compressed. FIG. 4 is a cross-sectional view illustrating a vicinity of the supporting member 58 in a state where the lower end of the brake lever 52 and the supporting member 58 are closest to each other. In the state illustrated in FIG. 4, the length of the coil spring 56 is at minimum. Even in this state, the tip end (point A) of the guide surface 58b abuts the contact portion of the second pitch portion 56a. In other words, in the parking brake device 10, the contact portion of the second pitch portion 56a constantly abuts the tip end (point A) of the guide surface 58b during a transition of the coil spring 56 from the set state to a state where the coil spring 56 is most compressed.

In the parking brake device 10 according to the present embodiment, adjacent windings of the coil spring 56 are in contact with each other in a range where the coil spring 56 is in contact with the tip end (point A) of the guide surface 58b of the supporting member 58. Therefore, an external force acting on the adjacent windings of the coil spring 56 is reduced at a portion where a requirement for endurance of the coil spring 56 is the greatest (the portion where the coil spring 56 comes into contact with the tip end of the guide surface 58b). Accordingly, a decrease in the endurance of the coil spring 56 can be suitably prevented.

In addition, the coil spring 56 comprises the first pitch portion 56b, the second pitch portion 56a, and the third pitch portion 56c in sequence from one end side of the coil spring 56, and the first pitch portion 56b that comes into contact with the guide surface 58b functions as a spring. Therefore, since there are fewer portions in which adjacent windings come into contact with each other and which the portion does not function as a spring, stress applied to the coil spring 56 can be reduced.

As a result, the present embodiment realizes a small-size parking brake device 10 in which the coil spring 56 has a length of 80-120 mm in a set state without having to increase the material strength of the coil spring 56 or increase the outside diameter of the coil spring 56.

Furthermore, in the present embodiment, specifications of the coil spring 56 are set such that, in a state where the coil spring 56 is set, the distance between one end (point B) of the contact portion where the adjacent windings of the second pitch portion 56a come into contact with each other to the tip end (point A) of the guide surface 58b is 3.0 to 5.0 mm and that the distance between another end (point C) of the contact portion to the tip end (point A) of the guide surface 58b is 3.0 to 5.0 mm. Therefore, the contact portion of the second pitch portion 56a constantly abuts the tip end (point A) of the guide surface 58b during a transition of the coil spring 56 from the set state to the state where the coil spring 56 is most compressed (the state illustrated in FIG. 4). As a result, the endurance of the coil spring 56 can be dramatically improved. In addition, since the distance from the one end (point B or point C) of the contact portion to the tip end (point A) of the guide surface 58b does not exceed 5 mm, the stress applied to the coil spring 56 can be suitably prevented from becoming excessively large.

FIG. 5 is a graph illustrating results of a verification experiment of the endurance of the coil spring 56 in which a distance from an end of the second pitch portion (contact portion) 56a to the tip end (point A) of the guide surface 58b in the set state is used as a parameter. An abscissa in FIG. 5 represents the number of operations performed on the parking brake lever, and an ordinate represents the distance from an end of the second pitch portion (contact portion) 56a to the tip end (point A) of the guide surface 58b. For the experiment, a coil spring was used whose material is SWC and which has a wire diameter of 1.2 mm, an inner diameter of 4.8 mm, and an outer diameter of 7.2 mm. In addition, the lengths of the first, second, and third pitch portions 56a to 56c of the coil spring 56 were determined such that a center of the second pitch portion (contact portion) 56a abuts the tip end (point A) of the guide surface 58b in the set state. Furthermore, the spring length of the coil spring 56 in the set state was set to 110 mm and the spring length of the coil spring 56 in the state where the coil spring 56 is most compressed was set to 85 mm. The respective dots in FIG. 5 indicate numbers of operations of the parking brake lever upon breakage of the coil spring 56. As is apparent from FIG. 5, by setting the distance from an end of the second pitch portion 56a to the tip end of the guide surface 58b in the set state to 3 mm or more, breakage of the coil spring 56 did not occur even after performing more than 200,000 operations of the parking brake lever. From the experiment result, it was revealed that the endurance of the coil spring 56 dramatically improves when the distance from the end of the second pitch portion 56a to the tip end of the guide surface 58b in the set state is set to 3 mm or more.

While the present embodiments have been described in detail, such embodiments are merely illustrative and are not intended to limit the scope of the claims. Techniques described in the scope of claims include various modifications and changes of the specific examples illustrated above.

For example, in the embodiment described above, the first pitch portion 56b and the second pitch portion 56c of the coil spring 56 are provided at the respective ends of the coil spring 56. However, the first pitch portion 56b and the second pitch portion 56a may only be provided on the one end where the guide surface 58b is provided.

In addition, the gaps are formed between the adjacent windings of the second pitch portion 56a in the natural state of the coil spring 56. However, the adjacent windings of the second pitch portion 56a may alternatively come into contact with each other in the natural state of the coil spring 56.

Furthermore, a plurality of supporting members may be provided and the guide surface may be formed on each of the supporting members. Alternatively, the guide surface may be formed on the side of the brake lever 52. In a case where a plurality of guide surfaces is provided, the second pitch portion may be arranged so that the contact portion is formed at a portion that abuts an end of each guide surface.

Moreover, in the coil spring 56, the coil pitch of the first pitch portion 56b, the coil pitch of the second pitch portion 56a, and the coil pitch of the third pitch portion 56c can be appropriately designed according to characteristics required for the coil spring 56. In addition, the coil pitch in each pitch portion need not be constant and may be arranged so as to continuously vary.

It is to be understood that the technical elements described in the present description and the drawings exhibit technical usefulness solely or in various combinations thereof and shall not be limited to the combinations described in the claims at the time of filing. Furthermore, the techniques illustrated in the present description and the drawings are to achieve a plurality of objectives at the same time, whereby technical usefulness is exhibited by attaining any one of such objectives.

1. A cable-operated device comprising:
a brake lever;
a cable having one end connected to the brake lever;
a supporting member that supports the cable along a pathway on which the cable is arranged; and
a coil spring having one end fixed to the brake lever and another end fixed to the supporting member, the cable being inserted in a hole within the coil spring,
wherein
at least one of the brake lever and the supporting member comprises a guide surface making contact with the coil spring from a lateral direction with respect to the coil spring, and
one end portion of the coil spring comprises a first pitch portion wound with a first pitch, a second pitch portion wound with a second pitch which is smaller than the first pitch, and a third pitch portion wound with a third pitch which is larger than the second pitch,
the first pitch portion, the second pitch portion, and the third pitch portion are arranged in order from a tip of the one end portion, and
when a primary load is applied to the coil spring, a length of the coil spring is 80 to 120 mm, adjacent windings of the first pitch portion are separated from each other, adjacent windings of the second pitch portion are in contact with each other, and the second pitch portion makes contact with a tip end of the guide surface.

2. The cable-operated device as in claim 1, wherein
when the primary load is applied to the coil spring, a first distance from one end of the second pitch portion to the tip end of the guide surface is 3 to 5 mm, and a second distance from another end of the second pitch portion to the tip end of the guide surface is 3 to 5 mm.

3. The cable-operated device as in claim 1, wherein
when no load is applied to the coil spring, the adjacent windings of the second pitch portion are separated from each other.

4. The cable-operated device as in claim 3, wherein
another end portion of the coil spring comprises a fourth pitch portion wound with the first pitch, a fifth pitch portion wound with the second pitch, and a sixth pitch portion wound with the third pitch, and
the fourth pitch portion, the fifth pitch portion, and the sixth pitch portion are arranged in order from a tip of the another end portion.

5. The cable-operated device as in claim 1, wherein
when no load is applied to the coil spring, the adjacent windings of the second pitch portion are separated from each other.

6. The cable-operated device as in claim 5, wherein
another end portion of the coil spring comprises a forth pitch portion wound with the first pitch, a fifth pitch portion wound with the second pitch, and a sixth pitch portion wound with the third pitch, and
the fourth pitch portion, the fifth pitch portion, and the sixth pitch portion are arranged in order from a tip of the another end portion.

7. The cable-operated device as in claim 1, wherein
another end portion of the coil spring comprises a forth pitch portion wound with the first pitch, a fifth pitch portion wound with the second pitch, and a sixth pitch portion wound with the third pitch, and
the fourth pitch portion, the fifth pitch portion, and the sixth pitch portion are arranged in order from a tip of the another end portion.
